(19) United States
(12) Patent Application Publication
(10) Pub. No.: US 2008/0216903 A1
(43) Pub. Date: Sep. 11, 2008

(54) FLOW REGULATOR

(76) Inventor: Gideon Lipshitz, Rishon LeZion (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/681,797

(22) Filed: Mar. 5, 2007

(51) Int. Cl. F16K 31/12

(52) U.S. Cl. 137/501; 239/533.1

(57) ABSTRACT

A flow regulator including a body that includes a first flow passageway and a second flow passageway, and a deformable blocking element disposed in the body, the deformable blocking element deforming due to pressure of fluid flow thereagainst, wherein the deformable blocking element is arranged to variably block the first flow passageway in accordance with its deforming due to pressure of fluid flow thereagainst, and wherein the deformable blocking element does not block fluid flow through the second flow passageway.

### FIELD OF THE INVENTION

The present invention relates generally to flow regulators, such as for showers, for maintaining a generally constant flow rate despite changing pressure.

### BACKGROUND OF THE INVENTION

Flow regulators are often used, such as in showers, for maintaining a generally constant flow rate despite changing pressure. An example of a typical design of the prior art (just one of many designs) includes a controller housing having a central body in a passage duct. The central body surrounds an annular throttle body, which is made from an elastic material. Water can flow through a control gap. The passage cross-section of the control gap varies by means of the throttle body deforming under the pressure difference generated as flow passes through. For example, the throttle body can be an O-ring. As the water pressure increases, the O-ring deforms and blocks more of the control gap. The result is a somewhat constant flow rate despite changing pressure.

A disadvantage of such designs is that the flow regulator is very sensitive to the elasticity of the elastomeric O-ring, or looked at in a different way, the hardness of the O-ring. Even a difference of 5 Shore in the hardness can significantly influence the flow rate performance. Another disadvantage is that the flow rate may be insufficient at low pressure.

### SUMMARY OF THE INVENTION

The present invention seeks to provide an improved flow regulators, such as for showers and other water (or any other liquid) flow products, as is described more in detail hereinbelow. In contrast with the prior art, the flow regulator of the present invention also has a fixed flow passage that is not affected by a changing, deformable throttle element.

There is provided in accordance with an embodiment of the present invention a flow regulator including a body that includes a first flow passageway and a second flow passageway, and a deformable blocking element disposed in the body, wherein the deformable blocking element is arranged to variably block the first flow passageway by deforming due to pressure of fluid flow thereagainst, and wherein the deformable blocking element does not block fluid flow through the second flow passageway.

In one embodiment, the first and second flow passageways are fluidly isolated from each other such that one portion of fluid passing through the body passes through the first flow passageway and another portion passes through the second flow passageway.

In one embodiment, the body includes an inner wall extending from a base that surrounds and defines an inner chamber and an outer wall extending from the base and spaced from the inner wall that surrounds the inner wall and defines an outer chamber in a volume between the inner and outer walls, wherein the first flow passageway is uniquely located in only one of the inner and outer chambers and the second flow passageway is uniquely located in the other chamber. For example, in one embodiment, the first flow passageway is uniquely located in the outer chamber and the second flow passageway is uniquely located in the inner chamber, and the deformable blocking element is disposed in the outer chamber. In one embodiment, the inner wall may be higher than the outer wall.

In one embodiment, the first flow passageway includes apertures formed through the base between the inner and outer walls and the second flow passageway includes at least one aperture formed through the base inwards of the inner wall. The apertures of the first flow passageway may or may not be symmetrically spaced about a center of the base. The second flow passageway may include a plurality of apertures symmetrically spaced about a center of the base.

There is also provided in accordance with an embodiment of the present invention shower apparatus including a shower device including a water inlet for entrance therethrough of water and a water exit for exit therethrough of water, and a flow regulator installed in the shower device near the water inlet, the flow regulator including a body that includes a first flow passageway and a second flow passageway, and a deformable blocking element disposed in the body, wherein the deformable blocking element is arranged to variably block the first flow passageway by deforming due to pressure of fluid flow thereagainst, and wherein the deformable blocking element does not block fluid flow through the second flow passageway.

### BRIEF DESCRIPTION OF THE DRAWINGS

The present invention will be understood and appreciated more fully from the following detailed description taken in conjunction with the drawings in which:

FIGS. 1A-1E are simplified illustrations of a flow regulator, constructed and operative in accordance with an embodiment of the present invention, wherein FIGS. 1A and 1B are sectional illustrations taken along respective lines A-A and B-B in FIG. 1D, FIG. 1C is an upstream view (that is, where the flow enters), FIG. 1D is a downstream view (that is, where the flow exits) and FIG. 1E is a perspective view; and

FIG. 2 is a simplified pictorial illustration of a water device (e.g., a shower handle), constructed and operative in accordance with an embodiment of the present invention, which employs the flow regulator of FIGS. 1A-1E.

### DETAILED DESCRIPTION OF EMBODIMENTS

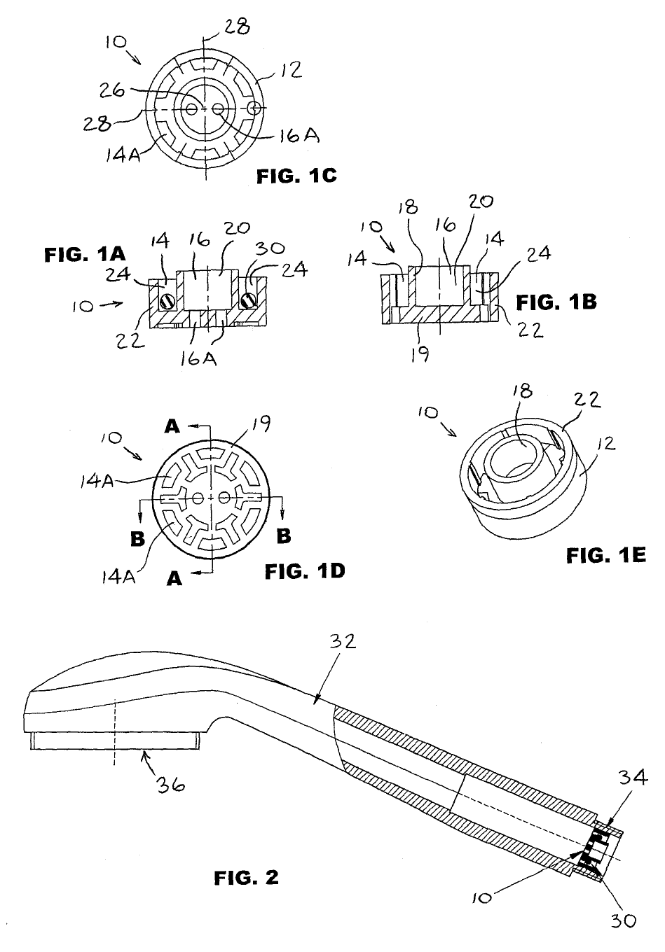

Reference is now made to FIGS. 1A-1E, which illustrates a flow regulator 10, constructed and operative in accordance with an embodiment of the present invention. The illustrated embodiment is exemplary, and the present invention is in no way limited by this particular illustrated construction.

Flow regulator 10 includes a body 12 that includes a first flow passageway 14 and a second flow passageway 16, described further below. Body 12 may be formed of any suitable material, such as but not limited to, injection molded plastic, metal, etc.

In one embodiment, the body 12 includes an inner wall 18 extending from a base 19 that surrounds and defines an inner chamber 20 and an outer wall 22 spaced from the inner wall 18 that surrounds the inner wall 18 and defines an outer chamber 24 in a volume between the inner and outer walls 18 and 22. The first flow passageway is uniquely located in only one of the inner and outer chambers and the second flow passageway is uniquely located in the other chamber. For example, in the illustrated embodiment, the first flow passageway 14 is uniquely located in the outer chamber 24 and the second flow passageway 16 is uniquely located in the inner chamber 20.

In one embodiment, the first flow passageway 14 includes apertures (designated 14A in FIG. 1D) formed through base 19 between the inner and outer walls 18 and 22, whereas the second flow passageway 16 includes one or more apertures (designated 16A in FIG. 1A) formed through the base 19 inwards of the inner wall 18. The apertures 14A of the first flow passageway 14 may be symmetrically spaced about a center 26 of base 19 (center 26 being at the intersection of centerlines 28 in FIG. 1C). At least some of the apertures 14A of the first flow passageway 14 may be flush with the outer wall 22 or the inner wall 18 or both. If the second flow passageway 16 includes more than one aperture 16A (as in the non-limiting illustrated embodiment), these apertures may be symmetrically spaced about center 26. The apertures 14A and 16A could be non-symmetrically positioned in an alternative embodiment.

Accordingly, the first and second flow passageways 14 and 16 are fluidly isolated from each other such that one portion of fluid passing through body 12 passes through the first flow passageway 14 and another portion passes through the second flow passageway 16. In the non-limiting illustrated embodiment, the inner wall 18 is higher than the outer wall 22.

A deformable blocking element 30, such as an elastomeric O-ring (just shown in FIGS. 1A and 2 for simplicity), is disposed in outer chamber 24 of body 12. Deformable blocking element 30 is sufficiently resilient to deform due to pressure of fluid flow thereagainst, such deformable elements being well known in the art. Deformable blocking element 30 is arranged to variably block the apertures of first flow passageway 14. For example, a high fluid pressure tends to flatten deformable blocking element 30 so that it blocks more of the apertures and decreases the area for fluid flow, thereby limiting fluid flow through the apertures of first flow passageway 14. However, deformable blocking element 30 does not block fluid flow through the second flow passageway 16. Thus, no matter what the pressure, fluid can always flow unobstructed through the second flow passageway 16. It has been found that this makes the fluid flow through the flow regulator of the present invention significantly less sensitive to the elasticity of the deformable blocking element than the prior art. In addition, the flow rate through the flow regulator of the present invention is adequate even at low pressure.

The present invention is not limited to a specific shape, and the size and shape of the apertures may be modified as required, as well as the material, shape and size of the deformable blocking element 30.

Reference is now made to FIG. 2, which illustrates a water device 32 (e.g., a shower handle), constructed and operative in accordance with an embodiment of the present invention, which employs the flow regulator 10 of FIGS. 1A-1E. The shower device includes a water inlet 34 for entrance therethrough of water and a water exit 36 for exit therethrough of water. The flow regulator 10 may be installed in the shower device near the water inlet 34 or in another suitable place. It is noted that the flow regulator 10 is not limited for use with showers. The flow regulator 10 can be any size and can be rated for any range of flow rates.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A flow regulator comprising:
a body that includes a first flow passageway and a second flow passageway; and
a deformable blocking element disposed in said body, wherein said deformable blocking element is arranged to variably block said first flow passageway by deforming due to pressure of fluid flow thereagainst, and wherein said deformable blocking element does not block fluid flow through said second flow passageway.

2. The flow regulator according to claim 1, wherein said first and second flow passageways are fluidly isolated from each other such that one portion of fluid passing through said body passes through said first flow passageway and another portion passes through said second flow passageway.

3. The flow regulator according to claim 1, wherein said body comprises an inner wall extending from a base that surrounds and defines an inner chamber and an outer wall extending from said base and spaced from said inner wall that surrounds said inner wall and defines an outer chamber in a volume between said inner and outer walls, wherein said first flow passageway is uniquely located in only one of said inner and outer chambers and said second flow passageway is uniquely located in the other chamber.

4. The flow regulator according to claim 3, wherein said first flow passageway is uniquely located in said outer chamber and said second flow passageway is uniquely located in said inner chamber, and said deformable blocking element is disposed in said outer chamber.

5. The flow regulator according to claim 3, wherein said inner wall is higher than said outer wall.

6. The flow regulator according to claim 4, wherein said first flow passageway includes apertures formed through said base between said inner and outer walls and said second flow passageway includes at least one aperture formed through said base inwards of said inner wall.

7. The flow regulator according to claim 6, wherein the apertures of said first flow passageway are symmetrically spaced about a center of said base.

8. The flow regulator according to claim 6, wherein at least some of the apertures of said first flow passageway are flush with said outer wall.

9. The flow regulator according to claim 6, wherein said second flow passageway includes a plurality of apertures symmetrically spaced about a center of said base.

10. The flow regulator according to claim 1, wherein said deformable blocking element comprises an elastomeric ring.

11. Shower apparatus comprising:
A shower device comprising a water inlet for entrance therethrough of water and a water exit for exit therethrough of water; and
a flow regulator installed in said shower device near the water inlet, said flow regulator comprising a body that includes a first flow passageway and a second flow passageway, and a deformable blocking element disposed in said body, wherein said deformable blocking element is arranged to variably block said first flow passageway by deforming due to pressure of fluid flow thereagainst, and wherein said deformable blocking element does not block fluid flow through said second flow passageway.
